(19) United States
(12) Patent Application Publication
(10) Pub. No.: US 2002/0194999 A1
(43) Pub. Date: Dec. 26, 2002

(54) Apparatus for preparing frozen beverages

(76) Inventor: David Ervin, Marrero, LA (US)

Correspondence Address: THOMAS S. KEATY, KEATY PROFESSIONAL LAW CORP., 2140 WORLD TRADE CENTER, NO. 2 CANAL STREET, NEW ORLEANS, LA, 70130, US

(21) Appl. No.: 09/892,041

(22) Filed: Jun. 26, 2001

(51) Int. Cl. A23L 1/00

(52) U.S. Cl. 99/275

(57) ABSTRACT

Frozen beverage mixing unit has a hollow housing with an open bottom. A shaving disc with a cutting knife is rotationally mounted inside the housing, the shaving disc being connected to a motor. A piston moves above the shaving disc pushing a frozen product placed on the shaving disc, into a contact with the cutting knife. A water pump delivers a predetermined amount of water on top of the shaving disc to wash away remnants of the shaved off product. The water is mixed with the shaved frozen product in a mixing container placed below the open bottom. A flavoring liquid, be it an alcoholic beverage or a non-alcoholic syrup, is delivered into the mixing container in a location below the shaving disc.

### BACKGROUND OF THE INVENTION

This invention relates to dispensing machines, and more particularly, to an apparatus for preparing liquids containing frozen substances, such as daiquiris, slush drinks, and the like.

Many beverages require a frozen or refrigerated component, which is usually mixed with flavored syrups, carbonated liquids, alcoholic liquid and other components. The taste and flavor of the drinks vary depending on the additional ingredients used, from fruit juice to cola syrup to alcoholic beverage. A restaurant or a bar that serves frozen drinks oftentimes is equipped with a battery of mixing and ice crushing machines that are required to prepare the product ordered by a customer. These machines take up a considerable amount of counter space, which adversely affects the efficiency of the operation, especially in locations where space is at a premium.

As a result, there exists a need for the creation of a mixing machine that can be used in the preparation of various types of concoctions with a frozen product, while occupying a minimum amount of space. The present invention contemplates provision of such type of a machine that can be used for producing daiquiris, frozen cocktails, frozen fruit drinks, non-alcoholic drinks with a frozen component, smoothies, and the like.

### SUMMARY OF THE INVENTION

It is, therefore, an object of the present invention to provide a mixing machine for producing a beverage having a frozen ingredient.

It is another object of the present invention to provide a machine for making frozen concoctions with alcoholic and non-alcoholic components.

It is a further object of the present invention to provide a machine for preparing frozen beverages that is easy to use and inexpensive to manufacture.

These and other objects of the present invention are achieved through a provision of a beverage mixing machine that has a shaving disc for crushing, or shaving off a frozen product and mixing the shaved off ingredient with alcoholic or non-alcoholic additives and water. The machine of the present invention has a hollow housing with an open bottom, within which a piston moves. A rotating shaving disc is mounted below the piston. A slab of a frozen product is placed on the shaving disc and is cut with a knife carried by the top surface of the disc. The piston pushes on the frozen product, moving it into a contact with the knife.

The piston is operated by a lever, which is operationally connected to a motor activated upon movement of the lever downwardly. While the product is being broken into pieces by the knife, the motor activates a water pump for delivery of the mixing water on top of the shaving disc. The water washes away the remnants of the frozen product and is then delivered to the same container where the frozen product has fallen through the open bottom. The water forms a necessary ingredient of the frozen beverage.

A secondary volumetric pump delivers the flavoring liquid downstream from the water nozzle, below the shaving disc. Since the flavoring syrup may be alcohol-based or non-alcohol based, the shaving disc does not come into contact with the flavoring additive, and the next beverage prepared by the unit is not contaminated with an undesirable ingredient or flavor. The alcoholic additive may be any beverage conventionally used in preparing frozen drinks, be it rum, vodka, gin, tequila, etc.

The open bottom of the housing may be made telescoping to allow extension of the bottom wall when a small container is filled. The beverage preparing machine of the present invention may be used for producing daiquiris, frozen cocktails, frozen fruit drinks, nonalcoholic drinks with a frozen component, smoothies, and the like.

Slabs of a frozen product are stored in a freezer and are portioned to produce one small size beverage, for instance 12 ounces. Two of the slabs may be used for producing a “medium” size drink of 20 ounces, and three such slabs may be used for making a “large” 32 ounce beverage. Of course, other sizes of the slabs may be prepared before hand for dispensing different size drinks, if desired.

### DETAILED DESCRIPTION OF THE DRAWINGS

Reference will now be made to the drawings, wherein like parts are designated by like numerals, and wherein

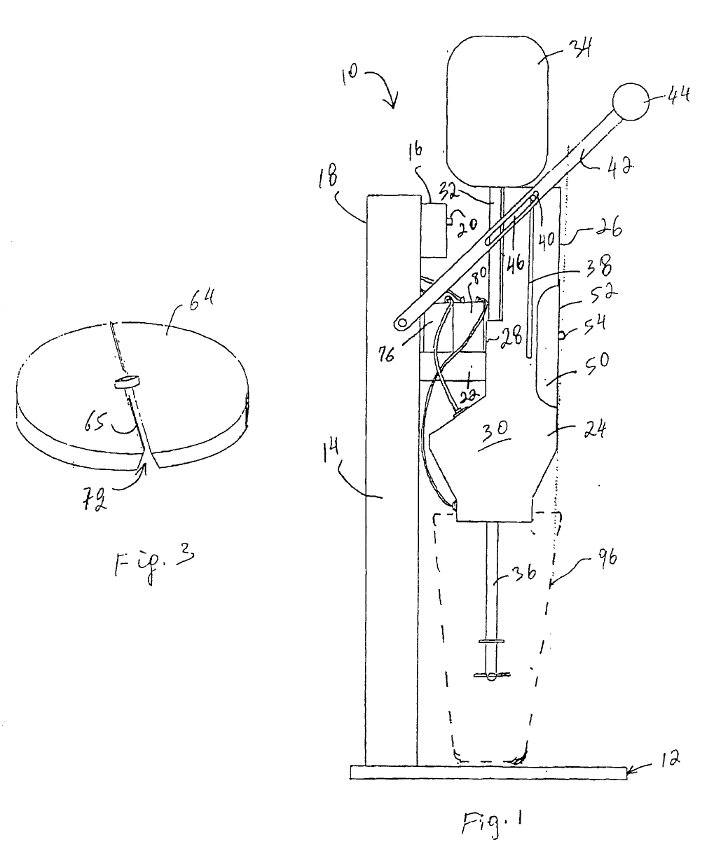

FIG. 1 is a side view of the apparatus of the present invention.

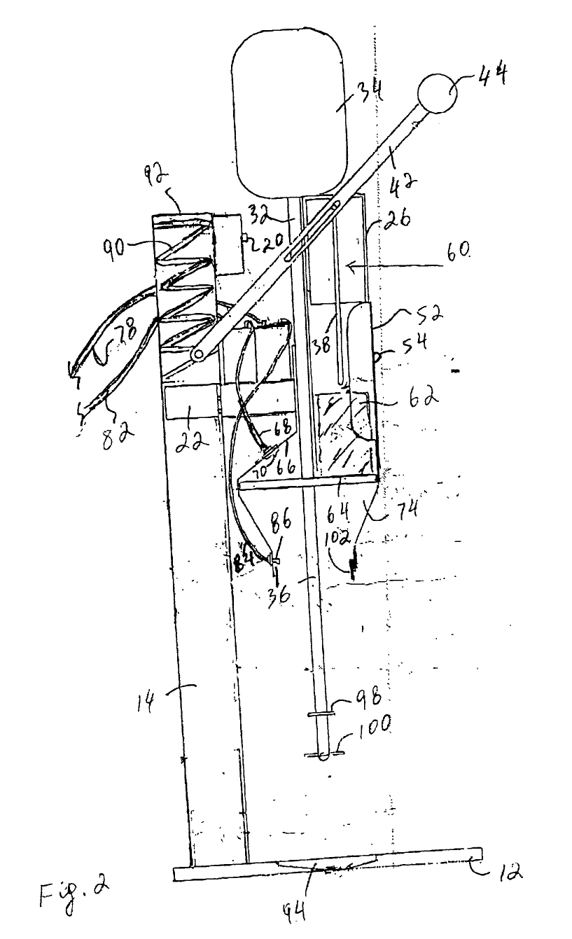

FIG. 2 is a side view, with a portion of the housing being removed for clarity to show operation of the machine.

FIG. 3 is a detail view of the shaving disk of the apparatus in accordance with the present invention.

### DETAIL DESCRIPTION OF THE PREFERRED EMBODIMENT

Turning now to the drawings in more detail, numeral 10 designates the apparatus for preparing frozen beverages in accordance with the present invention. As can be seen in the drawings, the unit 10 comprises a horizontal base 12 and an upright support 14 fixedly attached in a perpendicular relationship to the base 12. A control panel 16 is attached to the upright support 14 adjacent an upper portion 18 thereof. The control panel 16 is provided with several control buttons 20 (only one shown in FIGS. 1 and 2) for controlling the operation of the unit 10.

Secured below the control panel 16 is a retaining arm 22, which is fixedly attached to the upright support 14 and extends perpendicularly thereto. The retaining arm 22 carries a housing 24, which is provided with a front wall 26, a rear wall 28, and a sidewall 30. A second side wall is a mirror image of the wall 30 and is not shown in the drawings. Extending through the housing 24, and partially in parallel relationship to the rear wall 28, is a rotating motor shaft 32, which has one end connected to a motor 34 and a lower end connected to a mixing/stirring shaft 36.

The side wall 30 is provided with an elongated guiding slot 38 which extends from an upper part of the housing 24 to about mid section thereof. Sliding in the slot 38 is a lever pin 40. The pin 40 is secured to a plunger lever 42 that pivots about the pin 40 in an up and down movement. A grip 44 is provided at the front end of the plunger lever 42 to facilitate gripping by the user when operating the machine 10. An opening 46 is formed in the lever 42 to allow securing of the lever 42 to the pin 40.

The front wall 26 is provided with a cutout 50, which is covered by a door 52 to prevent splashing of the liquid and frozen particles during operation of the unit. The door 52 is provided with a handle or knob 54 to allow opening and closing of the door 52.

Mounted inside the hollow housing 24 is a plunger 60 which moves up and down upon manipulation of the plunger lever 42 by the user. The plunger 60 works as a piston, frictionally engaging the interior wall of the housing 24 and exerting a downward pressure on a slab of a frozen product 62 positioned inside the housing 24, as shown in FIG. 2. The slab 62 may contain different kinds of chopped fruit, carbonated beverage, syrups, and other ingredients depending on the recipe of the final product.

The motor shaft 32 carries a shaving, or cutting disk 64, which has a diameter slightly smaller than the interior wall of the housing 24. The shaving disc 64 has a razor-sharp knife 65 attached to an upper surface thereof for shaving or cutting the frozen product 62. The stirring/mixing shaft 36 is located below the shaving disk 64 and is co-axially, operationally connected to the motor shaft 32.

As can be seen in the drawings, a portion of the rear wall 28 of the housing 24 is provided with an inclined surface 66. An opening is formed in the wall portion 66 and a water conduit 68 is inserted into the opening. A water nozzle 70 is provided on the inner side of the wall 66 for delivering water into the housing 24 at a location above the shaving disk 64. The shaving disk 64 is provided with a radial slot 72 that allows the liquid and particles of shaved off frozen product to move below the shaving disk 64 into a dispensing chute 74 located below the disk 64. The dispensing chute 74 defines the open bottom of the housing 24.

The conduit 68 is fluidly connected to a water pump 76 which can be a conventional volumetric pump for precise measuring of the amount of water delivered through the conduit 68 into the housing 24. The intake of the pump 76 is connected to a water source (not shown) by a flexible conduit 78. The volumetric water pump 76 is mounted on the retainer arm 22.

Secured on the same arm 22 is a second volumetric pump 80, which has an intake connected by a flexible conduit 82 to a source of a liquid flavoring additive, be it an alcoholic beverage, carbonated beverage, syrup, and the like. The volumetric pump 80, similarly to the pump 76, is calibrated to deliver a desired volume of liquid into the conduit 84, eliminating guesswork from the mixing stage. Since all items are pre-measured, the unit 10 requires very little training of the operator.

The outlet of the secondary pump 80 is provided with a conduit 84 extending into the housing 24. An outlet nozzle is attached to the conduit 84 for delivering a pre-determined amount of the flavoring liquid into a mixing container, as will be described in more detail hereinafter. The nozzle 86 is located downstream from the shaving disc 64 to prevent flexible conduit 78. The volumetric pump 76 is mounted on the retainer arm 22. Secured on the same arm 22 is a second volumetric pump 80 which has an intake connected by a flexible conduit 82 to a source of liquid additive, be it an alcoholic beverage, carbonated beverage, syrup, and the like. The outlet of the pump 80 is provided with a conduit 84 extending toward the housing 24 and provided with an outlet tube 86 mounted on the housing wall 28 below the shaving disk 64.

A compression spring 90 is mounted inside the upper portion of the upright support 18 and is operationally connected to the free end of the plunger lever 42. The plunger lever 42 is forced downwardly by the user against the force of the spring 90 to move the plunger 60 downwardly into a contact with the block 62 of the frozen product. The front end of the spring 90 edges against the upper wall 92 of the upright support 14, while the lower end of the spring 90 edges against the retaining arm 22. The user moves the plunger 42 against the force of the compression spring 90 to operate the unit 10. A drip tray 94 is provided in the base 12 for collecting liquid residue when the unit is operated.

In operation, the user prepares a block 62 of the frozen product. The frozen product may be provided to the restaurant or bar by an outside source, or it can be prepared on the premises. Depending on the type of the product being dispensed, a concentrate is mixed with water, fruit, and other ingredients as suggested by the recipe. The liquid is then frozen in a container sized and shape to produce a block 62 that would fit within the housing 24. The user then opens the access door 52 and places the block or cube or cylinder of the frozen product 62 into the housing 24 and closes the door to prevent splashing. The user then pulls on the lever 44, forcing it down against the spring 90. The lever, being operationally connected to the motor 34, activates the motor which causes the shaft 32 to rotate and impart rotation to the shaving disc 64. The shaving control panel 16 to select the type and volume of the flavoring additive to be mixed with the frozen product. The user pulls on the lever 42, forcing it down against the force of the spring 90. The lever 42, being operationally connected to the motor 34, activates the motor, which causes the shaft 32 to rotate and impart rotation to the shaving disc 64.

The shaving disc 64, being provided with the sharp knife 65, cuts into the bottom surface of the frozen slab 62 and causes particles of the frozen product to separate from the frozen slab. The particles fall through the aperture 72 into the open bottom of the housing into the dispensing chute 74 and descend by gravity into a mixing cup 96. When the lever reaches its full downward position with the pin 40 sliding all the way down through the slot 38, the product 62 will have been all shaved and dispensed into the cup 96.

At the same time, the water pump 76 is activated, drawing water into the conduit 68 and flushing the shaving disc of any residue of the product that may remain on the shaving disc. The water, being a necessary ingredient of the finished product in any case, at the same time flushes the shaving disc 64, removing the taste and traces of the product from the disc and thereby making the machine ready for dispensing of a different type of flavor, if necessary.

The flavoring additive is also dispensed through activation of the secondary pump 80. The additive may be vodka, rum, tequila or a non-alcoholic syrup, depending on the customer order. The flavoring additive is delivered into the mixing container 96 at a location downstream from the shaving disc 64, thereby avoiding an undesirable mixing of flavors in the unit 10. The mixing shaft 36 is provided with mixing blades 98 and 100, which facilitate mixing of the frozen particles with water and flavoring in the container 96.

Depending on the size of the serving drink, the cup 96 may hold small, medium, or large size of the beverage. It is envisioned that one pull of the plunger lever 42 will cause dispensing of the “small” size beverage. The operator will move the plunger 42 twice or three times for the “medium” and “large” drink, respectively.

The slab of the frozen product 62 is dispensed every time when the lever is pulled down once, so that for medium size drinks or large size drinks the operator will need to replenish the frozen product two or three times depending on the desired volume of the beverage being served.

The cup 96 is then removed from its position below the chute 74 and the drink is dispensed into the serving container. Any liquid that may remain on the shaft 36 or on the stirring blades 98, 100 will drip into the removable tray 94 and can be wiped by the operator when necessary.

It is also envisioned that the motor 34 may be programmed to continue rotating the shaft 38 and the shaft 36 until after the predetermined amount of liquid from the water pump and the alcohol pump has been dispensed. In this manner, while the shaving disc 64 is still spinning, the water exiting from the nozzle 70 will continue to spray the disc 64 and make the unit ready for the next beverage. Since the water is necessarily present in the types of beverages prepared with the help of the unit 10, the water can be safely dispensed upstream from the nozzle 86.

Once the lever is released, the compression spring 90 will cause the lever to move into its normally upward position. The motor 34 stops and rotating shaft 32 and 36 seize to rotate. The pull of the lever 42 one more time will start the cycle again.

The frozen product slab 62 may contain any desired ingredients, for instance chopped fruit, ice cream, etc. The slabs 62 of the frozen product can be prepared before hand and stored in marked containers next to the unit 10 to be selected by the operator upon the customer's request. The alcohol dispensed through the conduit 82 can be in a locked location to prevent unauthorized use.

If desired, the control panel 16 may be provided with a counter to keep track of how many times the lever 42 is moved down for dispensing of the drink. This will provide a counting system for the owner to facilitate inventory control and deter theft of the product.

The ice chute 74 has a generally cylindrical bottom portion 102. This portion may be made telescoping to extend further downwardly if the cup 96 is small. The telescoping chute 102 may be extended to reach the top of a 4½″ cup, the standard small size cup. In that case, it is envisioned that the wall 102 can telescope up to 3½″ downward.

The unit 10 of the present invention requires minimal space on the counter and virtually no equipment maintenance. The energy consumption is considerably less in comparison with other ice shaving units. The variety of flavors and product types, with or without alcohol, is virtually limitless, allowing the operator to dispense a multitude of flavored drinks, slushies and other types of frozen concoctions.

The unit 10 is lightweight and easily transportable from one location to another and can be set up for operation in minutes as long as there is access to an A/C power or a battery. There is virtually no product waste as the perishable items are stored in a frozen state in a freezer until ready for dispensing. The finished product in consistent in texture and taste; it requires minimal involvement from the operator.

The control panel is pre-programmed and provided with buttons to allow selection of alcohol for the desired product by a switch with four or more settings. For instance, a standard daiquiri can have rum and water, tequila and water, vodka and water, or only water for non-alcoholic beverages. The alcohol and water source containers can be provided with level indicators that are connected to the control panel to alert the operator if there is low alcohol or water supply level.

Many other changes and modifications may be made in the design of the present invention without departing from the spirit thereof. I, therefore, pray that my rights to the present invention be limited only by the scope of the appended claims.

1. An apparatus for preparing beverages with a frozen product, comprising:
a hollow housing with an open bottom;
a piston moveable inside the housing;
a shaving disc with a cutting knife rotationally mounted below said piston, said shaving disc being adapted for shaving the frozen product positioned on said shaving disc, while the piston pushes downwardly against the frozen product to move the frozen product into a contact with the shaving disc.

2. The apparatus of claim 1, further comprising a water nozzle for delivering water on top of the shaving disc to wash away remnants of the frozen product from the shaving disc.

3. The apparatus of claim 1, wherein said housing comprises a dispensing chute in a lower portion of the housing, said dispensing chute having a telescoping wall for extending the length of said dispensing chute upon demand.

4. The apparatus of claim 2, further comprising a water pump for delivering a predetermined amount of water into said housing through said water nozzle.

5. The apparatus of claim 2, wherein said piston moves in response to movement of a lever operationally connected to said piston and to a motor.

6. The apparatus of claim 5, wherein said motor is provided with a rotating shaft extending into said housing, and wherein said rotating shaft is attached to the shaving disc such that activation of said motor causes rotation of said shaving disc.

7. The apparatus of claim 6, wherein said rotating shaft is connected to a mixing shaft extending below said shaving disc for mixing shaved off product with water in a location below said shaving disc.

8. The apparatus of claim 1, further comprising a means for delivering a flavoring liquid into said housing.

9. The apparatus of claim 8, wherein said means for delivering a flavoring liquid comprises a secondary pump having an outlet connected to a conduit, which extends into an interior of said housing below said shaving disc.

10. The apparatus of claim 9, wherein said secondary pump is a volumetric pump for delivering of a pre-determined amount of flavoring liquid.

11. The apparatus of claim 5, further comprising a compression spring secured to said lever for urging said lever into a normally upward position.

12. An apparatus for preparing beverages with a frozen product, comprising:
a base for positioning on a horizontal surface;
an upright support fixedly attached to said base;
a retainer arm attaches to said upright support and extending a distance above said base;
a hollow housing with an open bottom carried by said retainer arm;
a piston moveable inside the housing;
a shaving disc with a cutting knife secured on an upper surface of said shaving disc, said shaving disc being rotationally mounted below said piston, said shaving disc being adapted for shaving the frozen product positioned on said shaving disc, while the piston pushes downwardly against the frozen product to move the frozen product into a contact with the shaving disc.

13. The apparatus of claim 12, wherein said shaving disc is provided with a radial slot to allow shaved off product to drop through the open bottom into a mixing container removably positioned below said housing.

14. The apparatus of claim 12, further comprising a means for removing remnants of said frozen product from said shaving disc.

15. The apparatus of claim 14, wherein said means for removing remnants of the frozen product comprise a water nozzle for delivering water on top of the shaving disc, said water nozzle being fluidly connected to a water pump regulating the amount of water delivered through said water nozzle.

16. The apparatus of claim 15, wherein said water pump is mounted on the retainer arm outside of said housing.

17. The apparatus of claim 12, wherein said housing comprises a dispensing chute in a lower portion of the housing, said dispensing chute having a telescoping wall for extending the length of said dispensing chute so that the dispensing chute reaches at least a top portion of the mixing container.

18. The apparatus of claim 12, further comprising a means for delivering a flavoring liquid into said housing, said means for delivering a flavoring liquid comprising a secondary pump having an outlet connected to a conduit, which extends into an interior of said housing below said shaving disc.

19. The apparatus of claim 18, wherein said secondary pump is a volumetric pump for delivering of a pre-determined amount of flavoring liquid, said secondary pump being mounted on the retainer arm outside of said housing.

20. The apparatus of claim 12, wherein said piston moves in response to movement of a lever operationally connected to said piston and to a motor.

21. The apparatus of claim 20, wherein said motor is provided with a rotating shaft extending into said housing, and wherein said rotating shaft is attached to the shaving disc such that activation of said motor causes rotation of said shaving disc.

22. The apparatus of claim 21, wherein said rotating shaft is connected to a mixing shaft extending below said shaving disc for mixing shaved off product with water in a mixing container positioned under said open bottom.

23. The apparatus of claim 20, further comprising a compression spring secured to said lever for urging said lever into a normally upward position.
